(19) United States
(12) Patent Application Publication
(10) Pub. No.: US 2008/0246845 A1
(43) Pub. Date: Oct. 9, 2008

(54) CAMERA MODULE WITH COMPACT PACKAGING OF IMAGE SENSOR CHIP

(75) Inventor: FU-CHIEH CHAN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/843,566

(22) Filed: Aug. 22, 2007

(30) Foreign Application Priority Data
Apr. 4, 2007 (CN) 200710200389.4

(51) Int. Cl. H04N 5/225

(52) U.S. Cl. 348/207.2

(57) ABSTRACT

An exemplary camera module includes a lens holder, a lens module, a lens module, an image sensor chip, and an attaching member. The lens module is received in the lens holder. The lens module comprises a barrel and at least one lens received in the barrel. The image sensor chip comprises a photosensitive area configured for receiving light transmitted through the lens module. The attaching member is disposed at an end portion of the lens holder opposite to the lens module. The attaching member is configured for attaching the lens holder to the image sensor chip. The attaching member defines a light transmittance space configured for exposing the photosensitive area to the lens module.

### BACKGROUND

1. Technical Field

The present invention relates to camera modules and, particularly, to a camera module with a compact and small-sized package structure of an image sensor chip thereof.

2. Description of Related Art

With the ongoing development of micro-circuitry and multimedia technology, digital cameras are now in widespread use. High-end portable electronic devices, such as mobile phones and PDAs (Personal Digital Assistants), are being developed to be increasingly multi-functional. Many of these portable electronic devices are popularly equipped with digital cameras. To facilitate portability, such portable electronic devices tend to be compact, slim, and light. Accordingly, digital cameras incorporated in the portable electronic devices have also been required to be reduced in size and weight, yet to remain cost-effective.

FIG. 6 illustrates a typical digital camera module 40. The camera module 40 includes a lens holder 42, a lens module 43, and an image sensor chip 44. The lens holder 42 is a hollow chamber. The lens module 43 includes a barrel 432 and a lens 434 received in the barrel 432. The barrel 432 is partially received in and is threadingly engaged with the holder 42. An IR (infra-red) cut filter 46 is fixed to an inner wall of the lens holder 42 and is configured for protecting the image sensor chip 44 against injury from IR light. The image sensor chip 44 is typically attached onto/upon a printed circuit board 47. The image sensor chip 44 has a photosensitive area 441 formed on a top surface 440 thereof. The photosensitive area 441 is configured for receiving light signal transmitted through the lens module 43. A plurality of chip pads 442 are formed on the top surface 440 and surround the photosensitive area 441. A plurality of board pads 472 are formed on the printed circuit board 47. Each chip pad 442 is electrically connected to a corresponding board pad 472, via a respective wire 48. The lens holder 42 is mounted on the printed circuit board 47 so that the image sensor chip 44, the chip pads 442, the board pads 472, and the wire 48 are received therein.

In the camera module 40, the printed circuit board 47 needs to provide sufficient space not only for the image sensor chip 44 and the wire 48 but also to permit for the mounting of the lens holder 42. Thus, this kind of camera module 40 has a relative larger size and volume. To reduce the size and volume of the camera module to a certain degree, an approach has been developed, whereby an end portion 422 of the lens holder 42 is made thinner. However, such a thin lens holder 42 is not easily manufactured by an injection molding method. This difficulty results in a relatively high cost. As such, the camera module 40 has not proven to be economically suitable for slim and compact electronic products.

What is needed, therefore, is a camera module that is relatively compact and slim and that is economical to produce.

### SUMMARY

In accordance with a present embodiment, a camera module includes a lens holder, a lens module, a lens module, an image sensor chip, and an attaching member. The lens module is received in the lens holder. The lens module includes a barrel and at least one lens received in the barrel. The image sensor chip has a photosensitive area configured for receiving light transmitted through the lens module. The attaching member is disposed at an end portion of the lens holder, opposite to the lens module. The attaching member is configured for attaching the lens holder to the image sensor chip. The attaching member defines a light transmittance space shaped to expose the photosensitive area to the lens module.

Other advantages and novel features will be drawn from the following detailed description of at least one preferred embodiment, when considered in conjunction with the attached drawings.

### BRIEF DESCRIPTION OF THE DRAWINGS

Many aspects of the present camera module can be better understood with reference to the following drawings. The components in the drawings are not necessarily drawn to scale, the emphasis instead being placed upon clearly illustrating the principles of the present camera module. Moreover, in the drawings, like reference numerals designate corresponding parts throughout the several views.

FIG. 1 is a schematic, cross-sectional view of a camera module, according to a first present embodiment;

FIG. 2 is a schematic, cross-sectional view of a lens holder in the camera module of FIG. 1;

FIG. 3 is a schematic, cross-sectional view of an alternative lens holder in the camera module of FIG. 1;

FIG. 4 is a schematic, cross-sectional view of an alternative camera module, according to a second present embodiment;

FIG. 5 is a schematic, cross-sectional view of another alternative camera module, according to a third present embodiment; and

FIG. 6 is a schematic, cross-sectional view of a conventional camera module.

### DETAILED DESCRIPTION OF THE PREFERRED EMBODIMENT

Embodiments of the present camera module and projection system will now be described in detail below and with reference to the drawings.

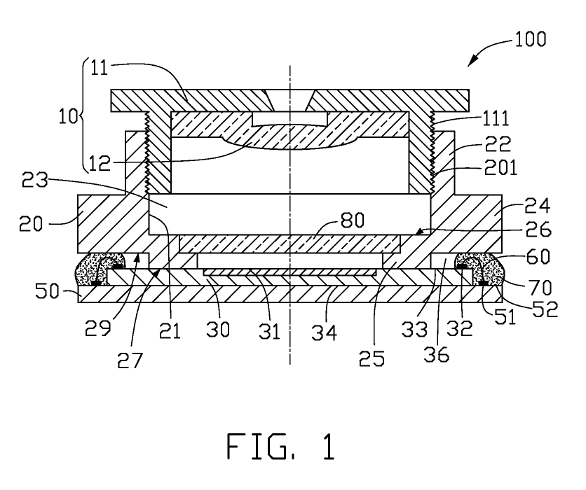

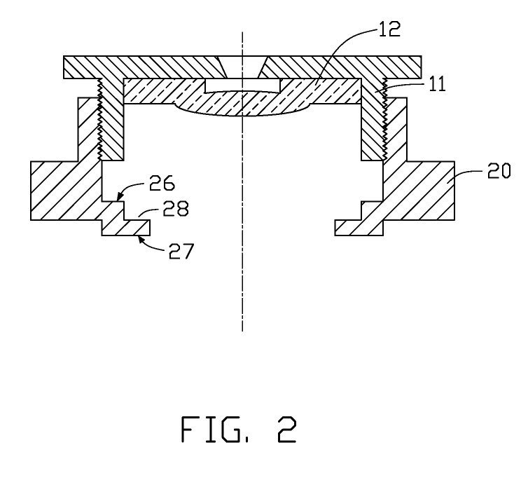

FIGS. 1 and 2 illustrate a camera module 100, in accordance with a first present embodiment. The camera module 100 includes a lens module 10, a lens holder 20, and an image sensor chip 30. The lens module 10 is partially received in the lens holder 20. The image sensor chip 30 is fixed to the lens holder 20.

The lens module 10 includes a barrel 11 and at least one lens 12. The barrel 11 is a hollow cylinder configured for receiving the at least one lens 11 therein. The barrel 11 has an external thread 111 formed on an external peripheral surface thereof. In the illustrated embodiment, the at least one lens 12 includes a lens. In other embodiments, the at least one lens 12 could include two or more lenses received in the barrel 11 .

The lens holder 20 has a front end 22 and a rear end 24, opposite to the front end 22, and defines a receiving cavity 23 penetrating/extending through the lens holder 20 from the front end 22 to the rear end 24. An internal thread 201 is formed on an inner periphery surface of the lens holder 20, beginning at or adjacent to the front end 22. The barrel 11 is partially received in the lens holder 20 by engaging the external thread 111 of the barrel 11 with the internal thread 201 of the lens holder 20. The lens holder 20 has a bottom surface 29, facing toward the image sensor chip 30.

An attaching member 25 is disposed on the rear end 24 of the holder 20 and is, advantageously, co-molded/integral therewith. The attaching member 25 is substantially an annular flange inwardly and radially protruding out of an inner peripheral surface 21 of the lens holder 20 adjacent to the rear end 24. A part of the attaching member 25 protrudes out of and away from the bottom surface 29. Accordingly, the attaching member 25 has an upper surface 26 and a lower attaching surface 27 disposed, respectively, in the receiving cavity 23 of the lens holder 20 and beyond the bottom surface 29.

The attaching member 25 is, advantageously, made of the same material as the lens holder 20. The attaching member 25 is, beneficially, integrally formed together with the lens holder 20, for example, via a molding process. Thus, the attaching member 25 is formed as a single piece with the lens holder 20. Accordingly, the image sensor chip 30 is fixed to the lens holder 20 via the attaching member 25, e.g., by adhering the attaching face 27 to the image sensor chip 30 via an adhesive. The adhesive could, e.g., be a double-sided adhesive or a curable adhesive.

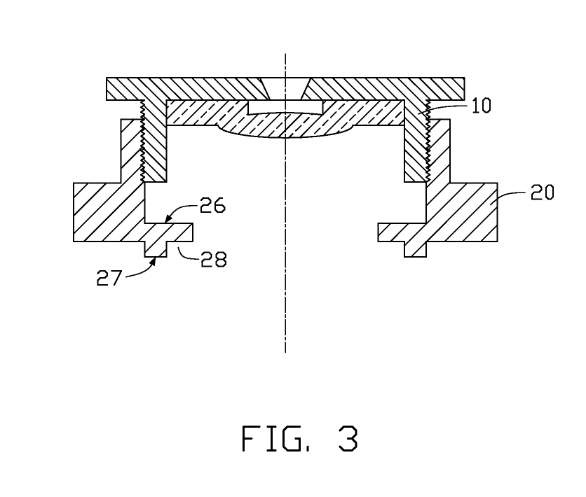

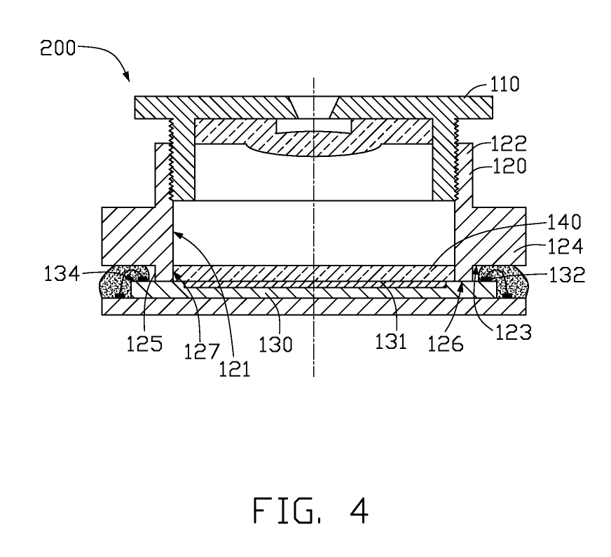

A transparent element 80 also is, advantageously, fixed to the attaching member 25 by, for example, an adhesive. The transparent element 80 serves to further protect the image sensor chip 30 and could, e.g., be an IR-cut filter or a light-transmittance glass. The attaching member 25 effectively defines a circular step-shaped recess 28 at the upper surface 26, as shown in cross-section in FIG. 3. The transparent element 80 is fixed into the recess 28 and is oriented essentially parallel to the lens 12. Alternatively, the step-shaped recess 28 is defined at the attaching surface 27, as shown in FIG. 4. The transparent element 80 is also fixed directly (e.g., via an adhesive) into the recess 28.

Referring to FIG. 2 again, the image sensor chip 30 is usefully disposed directly on a printed circuit board 50. The image sensor chip 30 has a first surface 33 facing towards the lens module 10 and a second surface 34 opposite to the first surface 33. The image sensor chip 30 has a photosensitive area 31 configured (i.e., structured and arranged) for receiving light transmitted through the lens module 10. A plurality of chip pads 32 are formed on the first surface 33 and surround the photosensitive area 31. A plurality of board pads 51 are formed directly on the printed circuit board 50 and surround the image sensor chip 30. Each chip pad 32 is electrically connected to a corresponding board pad 51, via a respective wire 60. The wires 60 are advantageously made of a highly conductive, oxidation-resistant (i.e., a quality promoting good long-term conductivity) material, such as gold, aluminum, or an alloy thereof.

The first surface 33 of the image sensor chip 30 is advantageously attached to the attaching surface 27 of the attaching member 25, for example, via an adhesive material interposed therebetween. The attaching surface 27 of the attaching member 25 advantageously surrounds the photosensitive area 31 and is surrounded by the chip pads 32, i.e., interposed between the photosensitive area 31 and the chip pads 32. The transparent element 80 and the attaching member 25 cooperatively form a package structure for the photosensitive area 31.

The rear end 24, the attaching member 25, the image sensor chip 30, and the printed circuit board 50 cooperatively define a peripheral interspace 36. The wires 60 are received in the interspace 36. An adhesive layer 70 is, advantageously, received in the interspace 36. The adhesive layer 70 is, beneficially, made of a curable adhesive material, for example, a silicone, epoxy, acrylic, or polyamide adhesive. The adhesive layer 70 extends between the bottom surface 29 of the holder 20 and a top surface 52 of the printed circuit board 50, thereby packaging the image sensor chip 30 therein. The rear end 24 could, advantageously, be thicker than the front end 22 of the lens holder 20, in order to provide sufficient adhering area on/adjacent the adhesive layer 70. In this case, the lens holder 20 and the printed circuit board 50 are strongly adhered and fixed to each other via the adhesive layer 70. Therefore, the attaching member 25 can closely contact the first surface 33 of the image sensor chip 30, without requiring adhesive material.

The adhesive layer 70 further beneficially covers the wires 60 and junctions of the wires 60, and the chip and board pads 32, 51, in order to protect the wires 60 from metal fatigue, to ensure the long-term connections between the ends of the wires 60 and the two pads 32, 51, and to adequately insulate the individual wires 60 to help avoid potential shorting. It is to be understood that the adhesive layer 70 could be applied to the peripheral edge of the interspace 36, apart from the image sensor chip 30, accordingly covering part of each wire 60 and junctions between the ends of the wires 60 and the board pads 51.

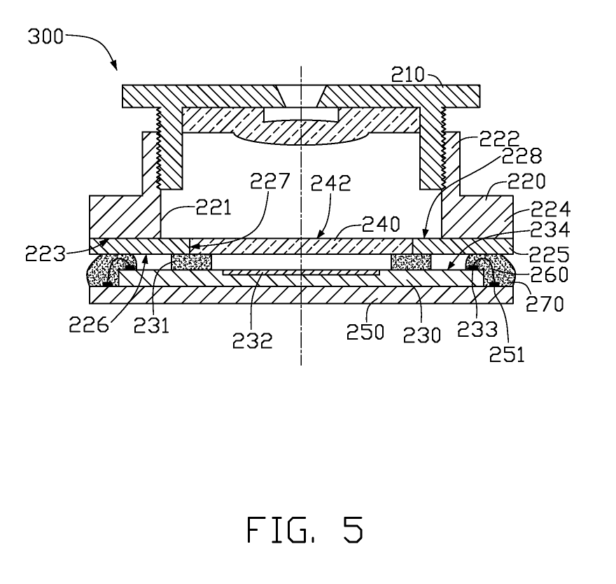

FIG. 5 illustrates a camera module 200, in accordance with a second present embodiment. The camera module 200 has a structure similar to the camera module 100. For example, the camera module 200 includes a lens module 110, a lens holder 120, and an image sensor chip 130, which, respectively, are essentially similar to the lens module 10, the lens holder 120, and the image sensor chip 30 of camera module 100. The lens holder 120 has an inner peripheral surface 121, an end face 123 facing towards the image sensor chip 130, a front end 122, and a rear end 124 opposite to the front end 122. The lens module 110 is partially received in the lens holder 120 at the front end 122. The image sensor chip 130 has a photosensitive area 131 formed on an upper surface 134 thereof. A plurality of chip pads 132 is formed on the upper surface 134 of the image sensor chip 130 and surrounds the photosensitive area 131.

The camera module 200 includes an attaching member 125 integrally projecting out of the rear end 124 of the lens holder 120 along an axial direction thereof. The attaching member 125 is, advantageously, a hollow cuboid, coaxial with the lens holder 120. The attaching member 125 usefully surrounds the photosensitive area 131 and is surrounded by the chip pads 132. The attaching member 125 has an attaching face 126 and an inner peripheral face 127 adjoining the attaching face 126. The attaching face 126 of the attaching member 125 is attached to the image sensor chip 130, e.g., via an adhesive. The inner peripheral face 127 is, advantageously, coplanar with the inner peripheral surface 121 of the lens holder 120.

The attaching member 125 is, advantageously, made of the same material as the lens holder 120. The attaching member 125 is, beneficially, integrally formed together with the lens holder 120, for example, via an injection molding process. Thus, the attaching member 125 is formed as a single piece with the lens holder 120. Accordingly, the image sensor chip 130 is fixed to the lens holder 120 via the attaching member 125, e.g., by adhering the attaching face 126 thereof to the image sensor chip 130.

The camera module 200 usefully includes a transparent element 140 fixed to the inner peripheral face 127 of the attaching member 125. The transparent element 140 could, e.g., be an IR cut filter or light transmittance glass. The transparent element 140 and the attaching member 125 cooperatively form a protective package structure for the photosensitive area 31. Alternatively, the transparent element 140 could be fixed directly to the inner peripheral surface 121 of the lens holder 120.

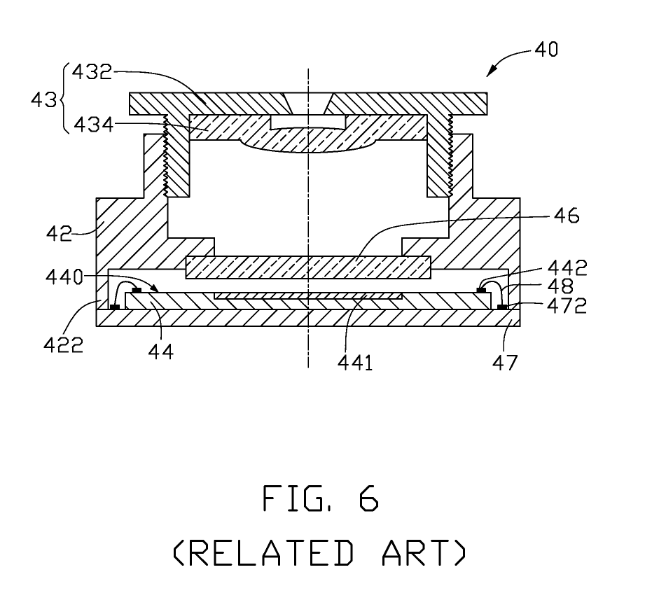

FIG. 6 illustrates a camera module 300, in accordance with a third present embodiment. The camera module 200 has an essentially same structure to the camera module 100. For example, the camera module 200 includes a lens module 210, a lens holder 220 and an image sensor chip 230, respectively, essentially similar to the lens module 10, the lens holder 120, and the image sensor chip 30 of the camera module 100. The lens holder 220 has an inner peripheral surface 221, an end face 223 facing towards the image sensor chip 221, a front end 222, and a rear end 224 opposite to the front end 222. The lens module 210 is partially received in the lens holder 220 at the front end 222. The image sensor chip 230 is disposed on a printed circuit board 250 and has a photosensitive area 232 formed on an upper surface 234 thereof. A plurality of chip pads 233 formed on the upper surface 234 is respectively connected to a plurality of board pads 251 formed on the printed circuit board 250, via corresponding wires 260.

The camera module 200 includes an attaching member 225. In this embodiment, the attaching member 225 is a circular gasket fixed to the rear end 224 of the lens holder 220, e.g., via a curable adhesive. The curable adhesive is, beneficially, made of a curable adhesive material, for example, a silicone, epoxy, acrylic, or polyamide adhesive. Usefully, the attaching member 225 inwardly projects out of the inner peripheral surface 221 along a radial direction of the lens holder 220. The attaching member 225 has an upper face 228, a lower attaching face 226 opposite to the upper face 228, and an inner peripheral face 227 adjoining the attaching face 126. The attaching face 226 of the attaching member 225 is attached to the image sensor chip 230.

A transparent element 240 is advantageously fixed to the inner peripheral face 227 of the attaching member 225. The transparent element 240 is substantially parallel to the image sensor chip 230. The transparent element 240 and the attaching member 225 are, advantageously, both adhered to the image sensor chip 230, e.g., via a double-sided adhesive 231. The double-sided adhesive 231 should, beneficially, be adhered at a circular junction of the transparent element 240 and the attaching member 225. The upper face 228 of the attaching member is, beneficially, adjusted to be parallel to an upper surface of the transparent member 240.

Quite suitably, the transparent member 240 and the attaching member 225 respectively cover a corresponding half of the double-sided layer 231. Thus, an inner edge of the attaching member 225 is adhered to and covers an outer half of the double-sided layer 231 adjacent to the chip pads 233. An outer edge of the attaching member 225 is adhered to the adhesive layer 270. The double-sided adhesive 231 are interposed between the photosensitive area 232 and the chip pads 233. Thus, the double-sided adhesive 231 and the transparent element 240 cooperatively form a protective package structure of/around the photosensitive area 232.

Alternatively, the transparent element 240 could, e.g., be fixed onto the upper face 228 of the attaching member 225. Thus, the transparent element 240, the attaching member 225, and the double-sided adhesive 231 would cooperatively form another package structure of/around the photosensitive area 232.

The camera module 300 includes an adhesive layer 270, essentially similar to the adhesive layer 70 of the camera module 1 00. In the illustrated embodiment, the adhesive layer 270 extends between a peripheral bottommost face of the attaching member 225 and a peripheral edge of the printed circuit board 250. Opportunely, the adhesive layer 270 covers each wire 260 and each respective junction between the ends of the wires 260 and the two pads 233, 251.

In assembling the camera module 300, the lens module 210 could, e.g., be firstly screwed into the lens holder 220. Secondly, the image sensor chip 230 is mounted/located on the printed circuit board 250. Then, each chip pad 233 is connected to a respective board pad 251 via a corresponding wire 260.

Thirdly, the double-sided adhesive 231 is applied on the upper surface 234 of the image sensor chip 230 and is interposed between the photosensitive area 232 and the chip pads 233. The transparent member 240 is adhered to the upper surface 234 of the image sensor chip 230, via the double-sided adhesive 231 and, simultaneously, is coaxially aligned with the photosensitive area 232. The transparent member 240 covers an inner half of the double-sided adhesive 231 adjacent to the photosensitive area 232.

Fourthly, an adhesive layer 270 is applied directly onto a peripheral edge of the printed circuit board 250 and covers each wire 260 and each respective junction between the ends of the wires 260 and the two pads 233, 251. An inner edge of the attaching member 225, e.g., gasket, is adhered to and covers outer half of the double-sided layer 231, adjacent to the chip pads 233. An outer edge of the attaching member 225 is adhered to the adhesive layer 270. The upper face 228 is adjusted to be parallel to an upper surface of the transparent member 240. Then, the adhesive layer 270 is cured, e.g., by heating or ultraviolet irradiation, thereby securing the attaching member 225 to the image sensor chip 230 and the printed circuit board 250.

Subsequently, a curable adhesive is applied to the upper face 228 of the attaching member 225. The lens holder 220 with the lens module 210 therein is located on the upper face 228 of the attaching member 225, via the curable adhesive, and is adjusted until the lens module 210 is properly focused on the photosensitive area 232. The adhesive layer 270 is cured, e.g., by heating or ultraviolet irradiation, accordingly securing the lens holder 220 to the attaching member 225.

It is to be understood that other assembling orders different from the assembling order above can also be employed, additionally or alternatively, to obtain the camera module 300. Moreover, the process of assembling of the camera modules 100 and 200 is essentially similar to the assembling of the camera module 300 mentioned above, except with respect to assembling of the attaching members 25 and 125. Regarding the attaching member 25, when the attaching member 25 and the lens holder 20 are separately formed, the assembling thereof is essentially similar to the assembling of the attaching member 225.

When the attaching member 25 and the lens holder 20 are configured as a whole (e.g., co-molded), as shown in FIG. 2, the assembling thereof is different from the assembling of the attaching member 225. In this circumstance, the attaching member 25, together with the lens holder 20, is secured to the upper surface 33 of the image sensor chip 30, via a double-sided adhesive or a curable adhesive. The bottom surface 29 is also adhered to the printed circuit board 50 via a curable adhesive. The transparent member 40 is fixed to the attaching member 25. The assembling of the attaching member 1 25 is essentially similar to the assembling of the attaching member 25.

In the camera modules 100, 200, and 300, the lens holder 20 is secured to the image sensor chip 30, not the printed circuit board 50. Therefore, the printed circuit board 50 does not require special space for mounting of the lens holder 20 thereto, thereby reducing size and weight of the camera modules 100, 200, and 300. Alternatively, the reduced special space of the printed circuit board 50 could be utilized in, e.g., readily and loosely distributing/arraying some required electronic elements (e.g., could thus be possible require less precision in placement of elements, due to greater space availability for such). That potential available space could be used to increase certified product ratio and/or facilitate manufacture of a high quality camera module, thereby decreasing production cost.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A camera module comprising:
a lens holder defining a hollow chamber therein;
a lens module received in the lens holder, the lens module comprising a barrel and at least one lens received in the barrel;
an image sensor chip comprising a photosensitive area configured for receiving light transmitted through the lens module; and
an attaching member disposed at an end portion of the lens holder opposite to the lens module, the attaching member being configured for attaching the lens holder to the image sensor chip, the attaching member defining a light transmittance space configured for exposing the photosensitive area to the lens module.

2. The camera module as claimed in claim 1, wherein the image sensor chip comprises a plurality of chip pads disposed on a first surface thereof, the photosensitive area being disposed on the first surface, the chip pads surrounding the photosensitive area, the attaching member being positioned between the chip pads and the photosensitive area.

3. The camera module as claimed in claim 2, wherein the image sensor chip has a second surface opposite to the first surface, the second surface being attached to a printed circuit board, the printed circuit board having a plurality of board pads disposed thereon, the plurality of board pads being correspondingly connected to the plurality of chip pads, via a plurality of wires.

4. The camera module as claimed in claim 3, wherein the lens holder, the attaching member, and the printed circuit board cooperatively define a peripheral interspace therebetween, an adhesive layer being disposed in the interspace.

5. The camera module as claimed in claim 4, wherein the adhesive layer is made of curable adhesive, the adhesive layer covering the wires and each respective junction between the wires and the chip and board pads.

6. The camera module as claimed in claim 4, wherein the lens holder, lens module, and the adhesive layer cooperatively form a package structure of the image sensor chip.

7. The camera module as claimed in claim 1, wherein the attaching member is a flange inwardly protruding from of the end portion of the lens holder, along a radial direction thereof, a portion of the flange protruding out of a bottommost face of the end portion.

8. The camera module as claimed in claim 7, wherein the attaching member defines a circular recess, a transparent member being fixed to the attaching member, the attaching member and the transparent member cooperatively forming a package structure around the photosensitive area.

9. The camera module as claimed in claim 8, wherein the attaching member has an upper face and a lower attaching face opposite to the upper face, the circular recess being defined at the upper face, the transparent member being fixed into the circular recess, the attaching face being attached to the image sensor chip.

10. The camera module as claimed in claim 8, wherein the attaching member has an upper face and a lower attaching face opposite to the upper face, the circular recess being defined at an inner peripheral part of the attaching face, the transparent member being fixed into the circular recess, an outer peripheral part of the attaching face being attached to the image sensor chip.

11. The camera module as claimed in claim 1, wherein the attaching member and the lens holder are configured as a whole.

12. The camera module as claimed in claim 1, wherein the attaching member is a flange extending from a bottommost face of the end portion of the lens holder, along an axial direction thereof.

13. The camera module as claimed in claim 1, wherein the attaching member is a gasket attached to the end portion of the lens holder.

14. The camera module as claimed in claim 13, wherein the gasket comprises an inner end and an outer end opposite to the inner end, the inner end protruding out of an inner peripheral surface of the lens holder, the inner end being attached to the image sensor chip, the outer end being attaching to the end portion of the lens holder.

15. The camera module as claimed in claim 13, wherein a transparent member is disposed on an internal peripheral surface of the gasket.

16. The camera module as claimed in claim 13, wherein a transparent member is disposed on an upper face of the gasket, facing towards the lens module.

17. The camera module as claimed in claim 1, wherein the attaching member is attached to the image sensor chip via one of a double-sided adhesive and a curable adhesive.

18. The camera module as claimed in claim 1, wherein the attaching member, together with the transparent member, is adhered to the image sensor chip via an adhesive, the transparent member and the adhesive cooperatively forming a package structure around the photosensitive area.

19. A camera module comprising:
a lens holder defining a hollow chamber;
a lens module received in the lens holder, the lens module comprising at least one lens disposed therein;
an image sensor chip comprising a photosensitive area disposed on an upper surface facing towards the lens module; and
an attaching member attached to the upper surface of the image sensor chip, the attaching member being configured for securing the lens holder to the image sensor chip, the attaching member defining a light transmittance space configured for exposing the photosensitive area toward the lens module.
